(19) United States
(12) Patent Application Publication
(10) Pub. No.: US 2026/0285235 A1
(43) Pub. Date: Sep. 24, 2026

(54) STEP WITH WEIGHING FUNCTION, RETRACTABLE STEP DEVICE AND VEHICLE APPARATUS

(71) Applicant: T-MAX (HANGZHOU) TECHNOLOGY CO., LTD., Hangzhou (CN)

(72) Inventors: Huizhong YANG, Hangzhou (CN); Zhaobo QING, Hangzhou (CN)

(21) Appl. No.: 19/569,920

(22) Filed: Mar. 17, 2026

(30) Foreign Application Priority Data
Mar. 18, 2025 (CN) 202510322803.7
Mar. 18, 2025 (CN) 202520479770.2
Mar. 18, 2025 (CN) 202520484408.4

(51) Int. Cl. B60R 3/02; G01G 19/12

(52) U.S. Cl. CPC B60R 3/02; G01G 19/12

(57) ABSTRACT

Disclosed are devices, systems and methods of use for a step with a weighing function, which includes a step body, a stepping plate, and a strain gauge. The step body has a support part, a weighing area part, a slot, and a deformation area part. The slot is arranged between the support part and the weighing area part to separate the support part and the weighing area part, and the deformation area part is connected between the support part and the weighing area part. The stepping plate is disposed on the weighing area part. The strain gauge is arranged on the deformation area part to deform along with deformation of the deformation area part

### CROSS-REFERENCE TO RELATED APPLICATIONS

The present application claims the benefits of and priorities to Chinese Patent Application No. 202510322803.7, filed on Mar. 18, 2025; Chinese Patent Application No. 202520479770.2, filed on Mar. 18, 2025; and Chinese Patent Application No. 202520484408.4, filed on Mar. 18, 2025. The entire contents of aforementioned patent applications are incorporated by reference for all purposes.

### TECHNICAL FIELD

This patent document relates to a step for a vehicle with weighing function, a retractable step device, and a vehicle apparatus.

### BACKGROUND

A vehicle step is a device mounted to a vehicle that provides a lower, stable foothold to make entering and exiting easier, especially on taller trucks, SUVs, and vans. A retractable vehicle step is a vehicle step that extends and retracts automatically, semi-automatically, or manually, improving ground clearance, aerodynamics, and aesthetics while reducing the risk of damage.

### SUMMARY

Disclosed are embodiments of a vehicle step with a weighing function, a retractable step device, and a vehicle apparatus, in accordance with the present technology.

Some embodiments of the present technology provide a step with a weighing function, including: a step body having a support part, a weighing area part, a slot, and a deformation area part, wherein the slot is provided between the support part and the weighing area part to separate the support part and the weighing area part and the deformation area part is connected between the support part and the weighing area part; a stepping plate disposed on the weighing area part; and a strain gauge disposed on the deformation area part to deform along with deformation of the deformation area part.

Some embodiments of the present technology further provide a vehicle apparatus, including a vehicle and a step, wherein the step is mounted on the vehicle, and includes: a step body having a support part, a weighing area part, a slot, and a deformation area part, wherein the slot is arranged between the support part and the weighing area part to separate the support part and the weighing area part and the deformation area part is connected between the support part and the weighing area part; a stepping plate arranged on the weighing area part; and a strain gauge arranged on the deformation area part to deform along with deformation of the deformation area part.

Some embodiments of the present technology further provide a retractable step device comprising: a mounting bracket; a drive shaft rotatably mounted on the mounting bracket; a step having a stepping surface, the step having a first side and a second side along the axial direction of the drive shaft; a first support arm assembly including a first drive arm and a first driven arm, a first end of the first drive arm being fixed to the drive shaft, a second end of the first drive arm being pivotally connected to the first side of the step, a first end of the first driven arm being pivotally connected to the mounting bracket, and a second end of the first driven arm being pivotally connected to the first side of the step; and a second support arm assembly including a second drive arm and a second driven arm, a first end of the second drive arm being fixed to the drive shaft, a second end of the second drive arm being pivotally connected to the second side of the step, a first end of the second driven arm being pivotally connected to the mounting bracket, and a second end of the second driven arm being pivotally connected to the second side of the step.

The subject matter described in this patent document can be implemented in specific ways that provide one or more of the following features.

### BRIEF DESCRIPTION OF THE DRAWINGS

FIG. 1 shows a perspective view of a step with a weighing function according to an example embodiment of the present technology.

FIG. 2 shows a partial cross-sectional view of a step with a weighing function according to an example embodiment of the present technology.

FIG. 3 shows an exploded view of a step with a weighing function according to an example embodiment of the present technology.

FIG. 4 shows an exploded view of a step with a weighing function according to an example embodiment of the present technology from another perspective.

FIG. 5 shows a perspective view of a step body of a step according to an example embodiment of the present technology.

FIG. 6 shows a perspective view of a step body of a step according to an example embodiment of the present technology from another perspective.

FIG. 7 shows a partial cross-sectional view of a step body of a step according to an example embodiment of the present technology.

FIG. 8 shows a perspective view of a retractable step device according to an example embodiment of the present technology.

FIG. 9 shows an exploded view of a retractable step device according to an example embodiment of the present technology.

FIG. 10 shows a perspective view of a step according to an example embodiment of the present technology.

FIG. 11 shows a perspective view of a mounting bracket of a retractable step device according to an example embodiment of the present technology.

FIG. 12 shows a schematic view of a vehicle apparatus according to an example embodiment of the present technology.

### DETAILED DESCRIPTION

A vehicle step is usually mounted at a position corresponding to a vehicle door under a vehicle to assist passengers in getting on and off. A conventional step for a vehicle is typically mounted on a bottom of a vehicle body. Yet, the step and a connection structure connecting the step with the vehicle can have a load-bearing limit. For instance, when the load on the step is too high, it is easy to cause deformation and damage, and even breakage, to the step or the connection structure between the step and the vehicle.

Conventional steps with a weighing function in the related art are provided with a plurality of weighing sensors, which can display the load on the step when a person steps on the step. However, the installation structure of the weighing sensors of conventional steps is complex, with many components, requiring higher precision to manufacturing and assembly, which results in high costs. Also, since the step is exposed to the external environment for a long time, and the external environment is complex and changeable, it is easy to lead to poor weighing accuracy and even failure of the weighing function. In addition, a conventional step device may also have the disadvantages of having a large volume and requiring a large installation space, making it unsuitable for a vehicle with a low chassis.

The present technology aims to solve one or more of the technical problems with conventional vehicle steps.

Disclosed are embodiments of a vehicle step with a weighing function, a retractable step device, and a vehicle apparatus, in accordance with the present technology.

Example embodiments of a step 100 with a weighing function according to the present technology are described below with reference to the accompanying drawings.

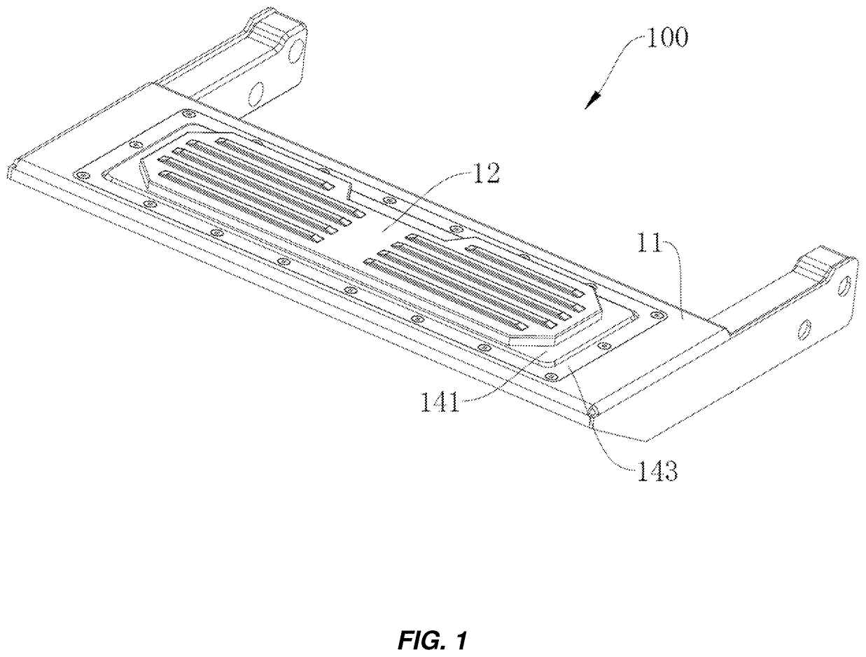

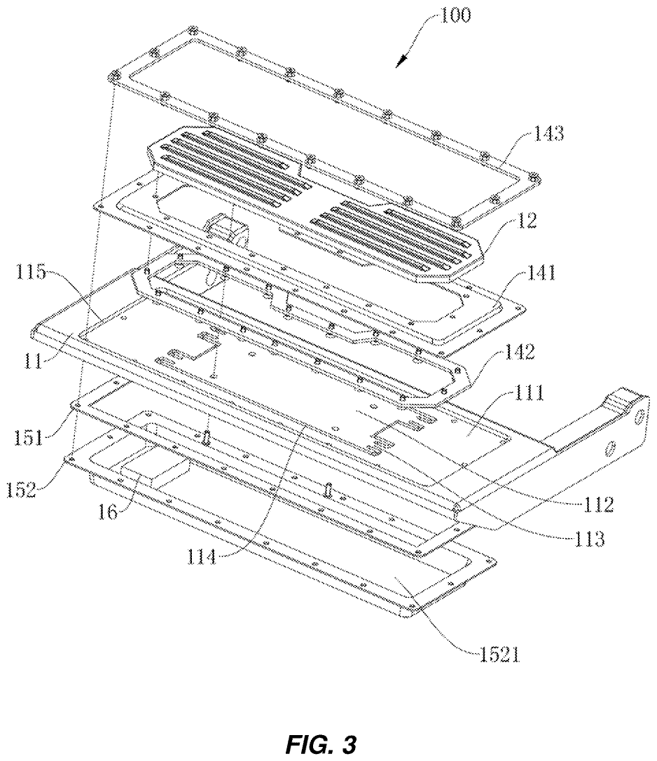

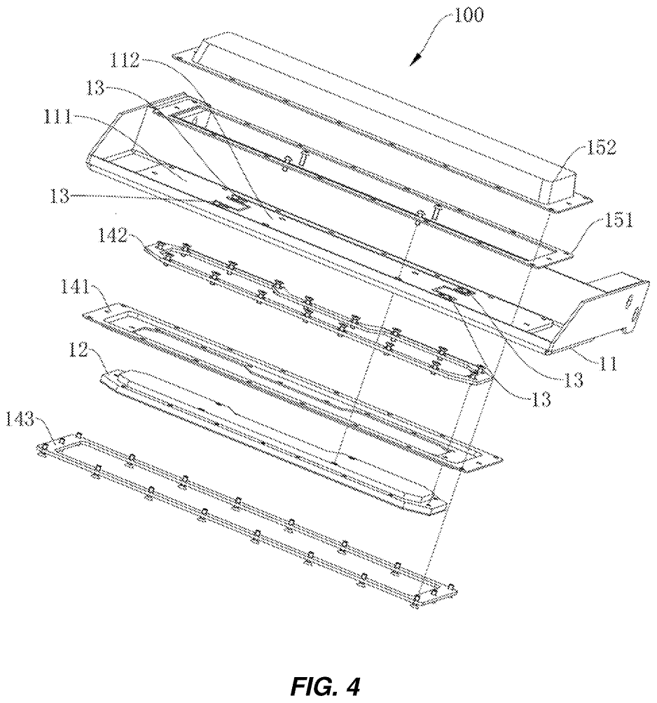

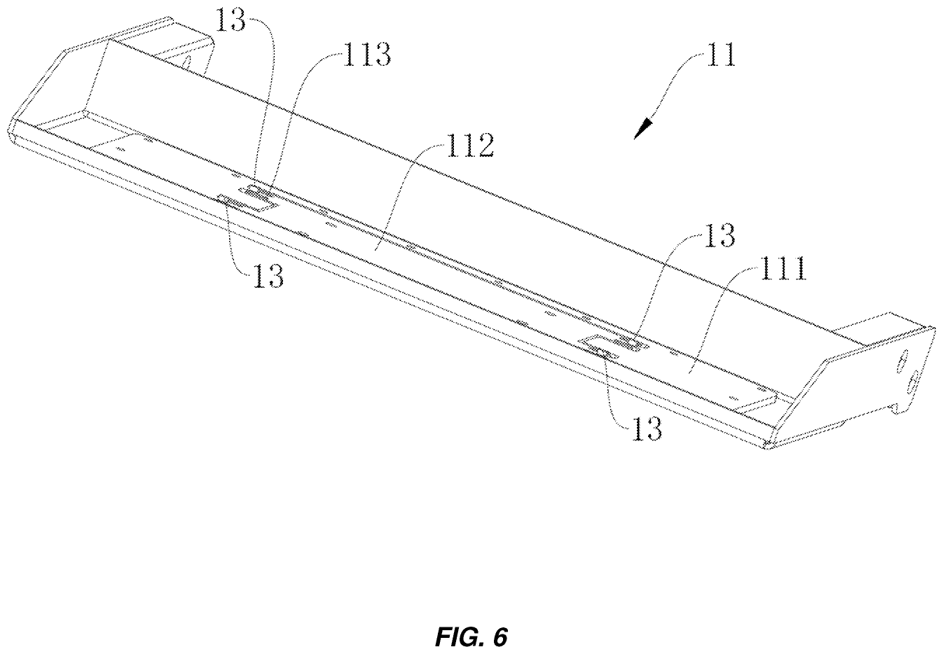

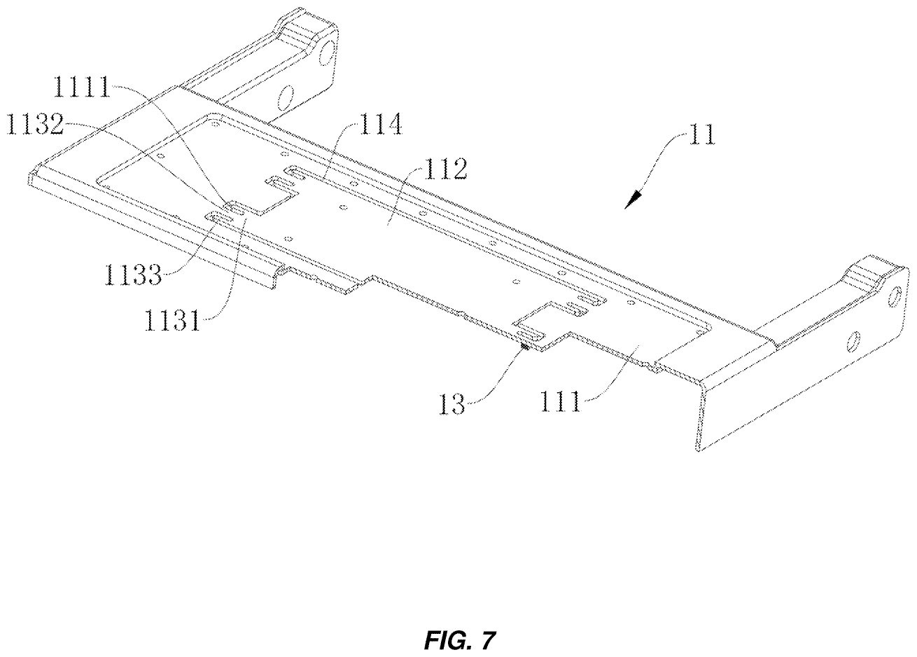

Referring to FIGS. 1 to 7, a step 100 with a weighing function according to example embodiments of the present technology includes a step body 11, a stepping plate 12, and a strain gauge 13. The step 100 may be mounted on a vehicle, for example, on a bottom of the vehicle body and adjacent to a lower edge of the vehicle's side door or tailgate of the vehicle, to assist passengers in getting on and off the vehicle. The step 100 may also be applied to other scenarios for assisting passengers in walking and for passengers to step on.

The step body 11 has a support part 111, a weighing area part 112, a slot 114, and a deformation area part 113. The slot 114 is provided between the support part 111 and the weighing area part 112 to separate the support part 111 and the weighing area part 112. The deformation area part 113 is connected between the support part 111 and the weighing area part 112. It can be understood that one of the support part 111 and the weighing area part 112 may surround the other. Preferably, the weighing area part 112 is located in the middle of the support part 111, and the support part 111 and the weighing area part 112 are concentric with each other.

In some example embodiments, preferably, a plurality of deformation area parts 113 are uniformly arranged at intervals along a peripheral direction of the weighing area part 112. The support part 111, the weighing area part 112, and the deformation area part 113 are all plate-shaped and integrally formed, and the plurality of deformation area parts 113 are arranged at intervals along the peripheral direction of the weighing area part 112. The weighing area part 112 may be circular, and the plurality of deformation area parts 113 are uniformly arranged along a circumferential direction of the weighing area part 112. Optionally, for example, the weighing area part 112 may be polygonal, such as rectangular or square, and the plurality of deformation area parts 113 are respectively located at the corners of the weighing area part 112.

The support part 111 and the weighing area part 112 are separated by the slot 114, and a plurality of deformation area parts 113 are connected between the support part 111 and the weighing area part 112. Thus, the slot 114 is divided into a plurality of segments of the slot 114 by the plurality of deformation area parts 113. When the weighing area part 112 is stressed, for example, when a passenger steps on the weighing area part 112, the weighing area part 112 is displaced relative to the support part 111, thereby causing the deformation area part 113 to deform.

The stepping plate 12 is disposed on the weighing area part 112. When a passenger steps on the stepping plate 12, the passenger's weight is applied to the weighing area part 112, and the deformation area part 113 deforms. The strain gauge 13 is disposed on the deformation area part 113, and the strain gauge 13 deforms along with the deformation of the deformation area part 113. Furthermore, the weight of the passenger on the stepping plate 12 can be measured through the deformation of the strain gauge 13.

In the step 100 with a weighing function in accordance with example embodiments of the present technology, the deformation area part 113 is formed between the support part 111 and the weighing area part 112, and the strain gauge 13 is attached to the deformation area part 113 to deform along with the deformation of the deformation area part 113, thereby forming a weighing sensor. In other words, a part of the weighing sensor (i.e., the deformation area part 113 where the strain gauge 13 is mounted) is composed of a part of the step 100.

For example, compared with the conventional weighing sensors in the related art, for steps with weighing function in accordance with the disclosed technology, there is no need to provide a separate additional elastic body for each strain gauge 13, and no need to adopt a separate additional installation structure to install each weighing sensor on the step body 11, which reduces the number of parts, and the overall structure, assembly, installation, disassembly, and maintenance are simple. In some example embodiments in accordance with the present technology, the processing and installation accuracy requirements of the weighing sensor are low, and the measurement accuracy is high. Moreover, for example, even if the step 100 is exposed to the external environment for a long time, the stability of its weighing accuracy and performance can be guaranteed.

Further example embodiments of the step 100 with a weighing function in accordance with the present technology are described below.

Referring to FIGS. 1 to 7, the step 100 includes a step body 11, a stepping plate 12, a strain gauge 13, a first pressing plate 142, a second pressing plate 143, an upper waterproof pad 141, a lower waterproof pad 151, and a lower cover plate 152.

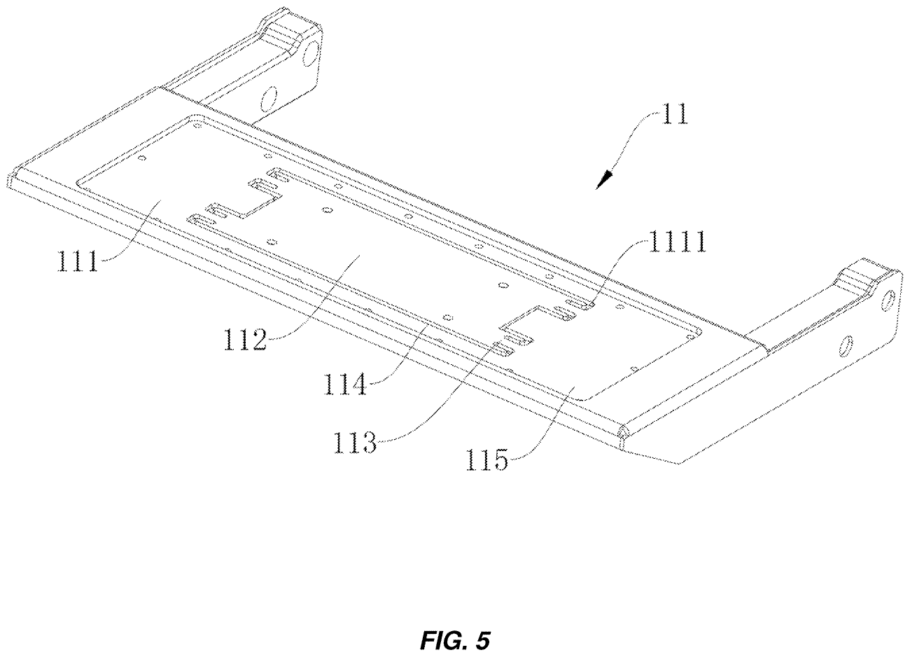

As shown in FIGS. 5 to 7, the step body 11 has a support part 111, a weighing area part 112, a slot 114, and a deformation area part 113. The middle of the upper surface of the step body 11 is recessed downward to form a recess 115, and the support part 111, the weighing area part 112, and the deformation area part 113 are all located in the recess 115.

The support part 111, the weighing area part 112, and the deformation area part 113 are plate-shaped and integrally formed. The support part 111, the weighing area part 112, and the deformation area part 113 may be located on substantially the same plane. For example, the support part 111, the weighing area part 112, and the deformation area part 113 are formed by cutting and/or stamping the same plate. Optionally, the support part 111, the weighing area part 112, and the deformation area part 113 may be integrally cast and formed by a mold. The support part 111 and the weighing area part 112 are directly connected through the deformation area part 113.

In some example embodiments of the present technology, the support part 111 is arranged around the weighing area part 112, the weighing area part 112 is located in the middle of the support part 111, and the support part 111 and the weighing area part 112 are concentrically arranged with each other. Both the weighing area part 112 and the support part 111 are rectangular, and there are four deformation area parts 113, which are respectively arranged at four corners of the rectangular weighing area part 112.

The slot 114 is provided between the support part 111 and the weighing area part 112 to separate the support part 111 and the weighing area part 112. The deformation area part 113 is connected between the support part 111 and the weighing area part 112. Specifically, the outer peripheral edge of the weighing area part 112 and the inner peripheral edge of the support part 111 are separated by the slot 114. Four grooves 1111 are provided at positions of the support part 111 corresponding to the four corners of the weighing area part 112. The grooves 1111 may be rectangular grooves. The four deformation area parts 113 are respectively located at the four corners of the weighing area part 112 and in the grooves 1111. The deformation area part 113 protrudes from the outer peripheral edge of the weighing area part 112, and the weighing area part 112 is rectangular, which can avoid the problem of stress concentration in local areas of the weighing area part 112, thereby preventing deformation in local areas of the weighing area part 112 after frequent compression, and thus preventing a decrease in measurement accuracy.

In some example embodiments of the present technology, the deformation area part 113 includes a deformation base 1131, a deformation beam 1132, and a cantilever beam 1133. The deformation base 1131 is connected to the support part 111, a first end of the deformation beam 1132 is connected to the deformation base 1131, and a second end of the deformation beam 1132 is connected to the weighing area part 112. A fixed end of the cantilever beam 1133 is connected to the deformation base 1131, and cantilever beams 1133 are respectively provided on two sides of the deformation beam 1132. The deformation base 1131 and the cantilever beam 1133 are separated from the support part 111 by the slot 114, the cantilever beam 1133 and the deformation beam 1132 are separated by the slot 114, and the deformation beam 1132 and the two cantilever beams 1133 are substantially M-shaped.

The strain gauge 13 is disposed on the deformation beam 1132. Specifically, the strain gauge 13 may be directly attached to the surface of the deformation beam 1132. For example, the strain gauge 13 may be bonded to the deformation beam 1132, so that it can promptly respond to the deformation of the deformation area part 113 with a simple overall structure and high measurement accuracy.

The deformation area part 113 may adopt a segmented structure design with the deformation base 1131 and the deformation beam 1132. The width of the deformation base 1131 is greater than the width of the deformation beam 1132, which can optimize the stress distribution of the deformation area part 113, avoid the problem of local stress concentration, and improve fatigue resistance while ensuring the deformation sensitivity of the deformation beam 1132.

The cantilever beam 1133 and the deformation beam 1132 may be arranged in parallel and at intervals, and the cantilever beam 1133 and the support part 111 are separated by the slot 114. By providing the cantilever beam 1133, the width of the slot 114 in the area corresponding to the deformation beam 1132 can be reduced, making the width of the slot 114 consistent, optimizing the structure of the step body 11 and facilitating manufacturing.

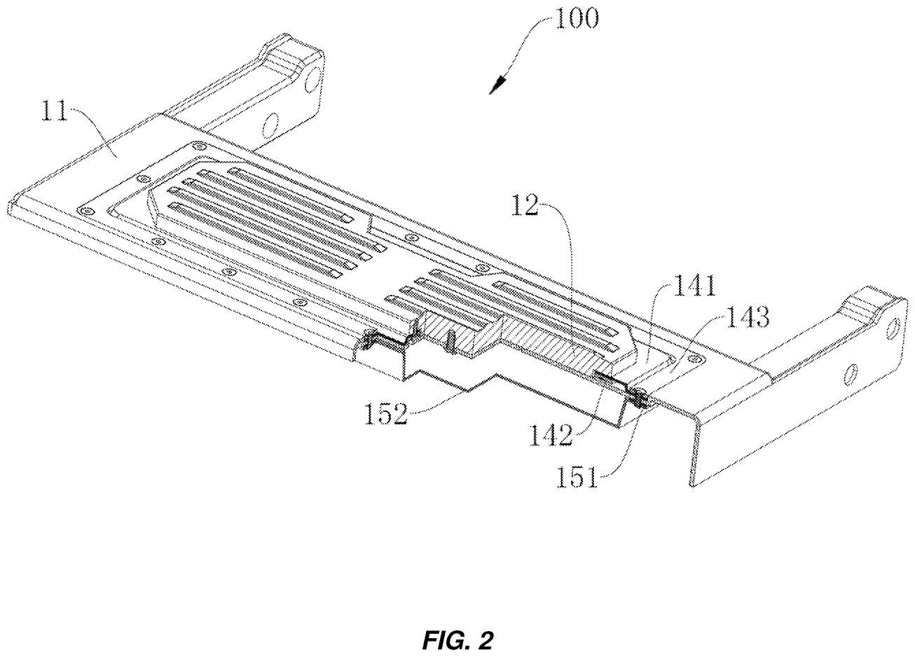

As shown in FIGS. 2 to 4, in this example embodiment, the stepping plate 12 is disposed on the weighing area part 112, and the upper waterproof pad 141 is disposed between the stepping plate 12 and the step body 11. The upper waterproof pad 141 is deformable, and the upper waterproof pad 141 may be made of flexible rubber or other materials. Preferably, for example, the upper waterproof pad 141 is a rubber pad, and the height of the inner peripheral edge of the upper waterproof pad 141 is larger than the height of the outer peripheral edge of the upper waterproof pad 141. The first pressing plate 142 and the second pressing plate 143 may be annular. Preferably, for example, the first pressing plate 142 is an integrated rectangular ring, and the second pressing plate 143 is an integrated rectangular ring. The inner peripheral edge of the upper waterproof pad 141 is press-fitted between the lower surface of the stepping plate 12 and the first pressing plate 142, and the outer peripheral edge of the upper waterproof pad 141 is press-fitted between the upper surface of the step body 11 and the second pressing plate 143.

The upper waterproof pad 141 and the second pressing plate 143 are located in the recess 115. The outer peripheral edge of the upper waterproof pad 141 is press-fitted between the second pressing plate 143 and the bottom surface of the recess 115, and the outer peripheral edge of the second pressing plate 143 abuts against the peripheral side wall of the recess 115, which can reduce the gap between the second pressing plate 143 and the peripheral side wall of the recess 115 to ensure the components fit more closely.

The upper surface of the second pressing plate 143 and the upper surface of the inner peripheral edge of the upper waterproof pad 141 are substantially flush with the upper surface of the step body 11. The upper end surface of the stepping plate 12 is higher than the exposed upper end surfaces of the upper waterproof pad 141 and the step body 11. On the one hand, it can prevent liquid from accumulating on the step 100 and allow rainwater to slide off the step 100 as soon as possible. On the other hand, for example, when a passenger steps on the step 100, the passenger's weight can be concentrated on the stepping plate 12, and when the passenger's weight is applied to the weighing area part 112, the weighing area part 112 is displaced relative to the support part 111, and then the deformation beam 1132 deforms. The deformation amount of the strain gauge 13 can more accurately reflect the weight of the person on the stepping plate 12.

The first pressing plate 142 and the second pressing plate 143 may be made of a metal plate or a plastic plate with a certain hardness. After the first pressing plate 142 and the stepping plate 12, and the second pressing plate 143 and the step body 11 are connected by a fastener such as a bolt, the inner peripheral edge of the upper waterproof pad 141 and the stepping plate 12, and the outer peripheral edge of the upper waterproof pad 141 and the step body 11 can be closely attached together, so that the top of the step 100 is sealed, preventing water, mud and other debris from entering the inside of the step 100 from above the step 100.

The lower cover plate 152 is connected to the lower surface of the step body 11, and the lower waterproof pad 151 is disposed between the lower cover plate 152 and the step body 11. The lower waterproof pad 151 may be made of flexible rubber or other materials. For example, the lower waterproof pad 151 is a rubber gasket. The peripheral direction of the lower cover plate 152 is fixedly connected to the step body 11 by a fastener such as a bolt, and the lower waterproof pad 151 is press-fitted between the lower cover plate 152 and the step body 11, thereby preventing water, mud and other debris from entering the inside of the step 100 from below the step 100.

Since the step 100 is usually exposed to the external environment, the internal structure of the step 100 is easily eroded by rain and snow when encountering rainy and snowy weather. When the step 100 is applied to a vehicle, if the vehicle wades or travels on a muddy road, the step 100 is easily immersed in water or adhered with mud, causing water, mud and other debris to enter the internal structure of the step 100. To this end, in example embodiments of the present technology, the upper waterproof pad 141, the lower waterproof pad 151, and the lower cover plate 152 are provided to seal the step 100, ensuring that the weighing performance of the step 100 is not affected by the external environment.

The lower cover plate 152 has an accommodating cavity 1521. A circuit board 16 connected to the strain gauge 13 is provided within the accommodating cavity 1521. The circuit board 16 can convert the deformation of the strain gauge 13 into an electrical signal output to obtain the weight of the weighed object, and then display the weight through a display screen and/or give an overload warning through an alarm.

In the step 100 with a weighing function in accordance with the present technology, the deformation area part 113 is formed between the support part 111 and the weighing area part 112, and the strain gauge 13 is attached to the deformation area part 113 to deform along with the deformation of the deformation area part 113, thereby forming a weighing sensor.

For example, as compared with the weighing sensors for conventional steps in the related art, in contrast, for the example embodiments of steps with weighing function in accordance with the present technology, there is no need to provide a separate additional elastic body for each strain gauge 13, and no need to adopt a separate additional installation structure to install the weighing sensor on the step body 11, which reduces the number of components used, and the overall structure, assembly, installation, disassembly, and maintenance are simple. The processing and installation accuracy requirements of the weighing sensor are low, and the measurement accuracy is high. Even if the step 100 with a weighing function is exposed to the external environment for a long time, the stability of its weighing accuracy and performance can be guaranteed.

A vehicle step is usually mounted at positions corresponding to the door of the vehicle to assist passengers in getting on and off the vehicle. For conventional steps in the related art, a retractable step device (where the step is mounted on the vehicle through a retractable mechanism), when in use, the step extends from the bottom of the vehicle; and when not in use, the step retracts below the bottom of the vehicle. Conventionally, when the step is in the retracted state retracted below the bottom of the vehicle, the structure of the retractable step device is not compact. For example, the size in the up-down direction is large, resulting in a large volume and occupying a large space, which affects the passability (e.g., clearance) of the vehicle with respect to ground, especially for a new energy vehicle such as an electric vehicle with low chassis.

To this end, the present technology provides a retractable step device, which has a small thickness and volume in the retracted state and is suitable for a vehicle with low chassis.

A retractable step device 200 according to some example embodiments of the present technology is described below with reference to the accompanying drawings.

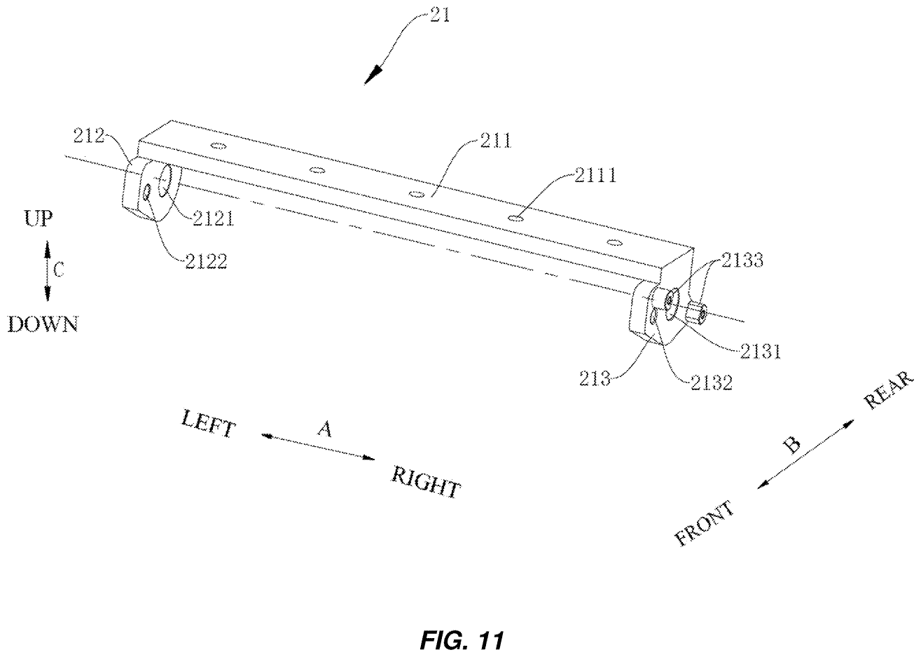

Referring to FIGS. 1 to 11, the retractable step device 200 according to some example embodiments of the present technology includes a retractable assembly 201 and a step 100. The retractable assembly 201 is connected to the step 100 to drive the step 100 to move between an extended position and a retracted position. The step 100 may be the step 100 with the weighing function described in the above embodiments.

The retractable step device 200 of some example embodiments of the present technology may be mounted on a vehicle, for example, on the bottom of the vehicle body and adjacent to the lower edge of the vehicle's side door or tailgate, to assist passengers in getting on and off the vehicle. The retractable step device 200 may also be applied to other scenarios for users to step on.

The retractable step device of example embodiments of the present technology can reduce the requirement for installation space and improve its practicality and safety by controlling the retractable movement of the step 100. For example, the retractable step device can be mounted on a vehicle, which can be applied to a vehicle with lower chassis. At the same time, during the normal driving of the vehicle, the step 100 is in the retracted position to avoid collision of the step 100.

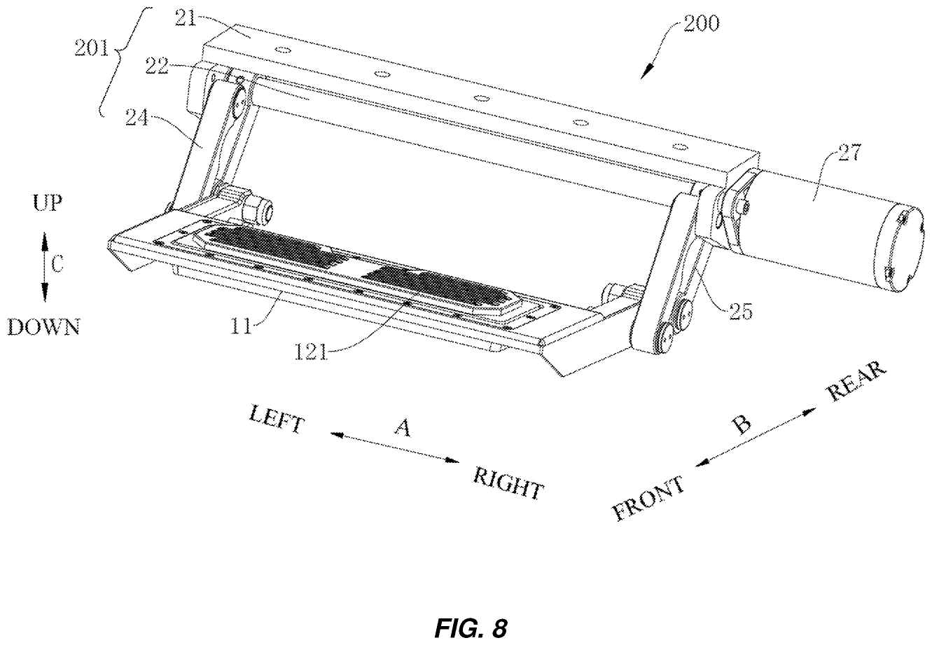

As shown in FIGS. 8 to 11, the retractable assembly 201 includes a mounting bracket 21, a drive shaft 22, a first support arm assembly 24, a second support arm assembly 25, and a drive motor 27.

The drive shaft 22 is rotatably mounted on the mounting bracket 21, and the mounting bracket 21 is used to be connected to the vehicle body of the vehicle. As described above, the mounting bracket 21 may be mounted to the bottom of the vehicle body. The drive shaft 22 may be driven by a driver, such as a drive motor 27, mounted on the mounting bracket 21 to rotate in the forward and reverse directions.

The axis of the drive shaft 22 is denoted as X in the figures, and the axial direction of the drive shaft 22 may be denoted as direction A in the figures. In the description of the present technology, direction A may be the left-right direction, and direction B may be the front-rear direction orthogonal to the left-right direction. When the retractable step device 200 is mounted near the side door of the vehicle, direction A is the front-rear direction of the vehicle, direction B is the left-right direction of the vehicle, which is also referred to as the inner-outer direction, and the up-down direction is the up-down direction of the vehicle (i.e., the vertical direction). It can be understood that when the retractable step device is mounted near the tailgate of the vehicle, direction A may be the left-right direction of the vehicle, and direction B may be the front-rear direction of the vehicle, which is also referred to as the inner-outer direction. In the description of the following example embodiments, unless otherwise specified, the orientation and direction when the retractable step device is mounted near the side door of the vehicle are used for description.

The structure of the step in the retractable step device 200 of the embodiment here is the same as that of the step with the weighing function in the above embodiments and will not be repeated.

In this example embodiment, the step 100 is movable between an extended position and a retracted position. The step 100 has a stepping surface 121 for passengers to step on when getting on and off the vehicle. In the extended position, the stepping surface 121 of the step 100 faces substantially upward. It can be understood that during the movement of the step 100 between the extended position and the retracted position, the orientation of the stepping surface 121 of the step 100 may remain upward or may change. Thus, according to the orientation of the bottom of the vehicle body, the step 100 may be at different angles in the retracted position. For example, when the bottom of the vehicle body is horizontal, the step 100 is in a horizontal state, that is, the stepping surface 121 faces upward; when the bottom of the vehicle body is inclined, the step 100 is also inclined in the retracted position, so that the step 100 can better fit with the vehicle in the retracted position, improving the passability of the vehicle.

The step 100 has a first side and a second side along the axial direction of the drive shaft 22. In FIGS. 8 to 10, the first side of the step 100 is the left side, and the second side of the step 100 is the right side.

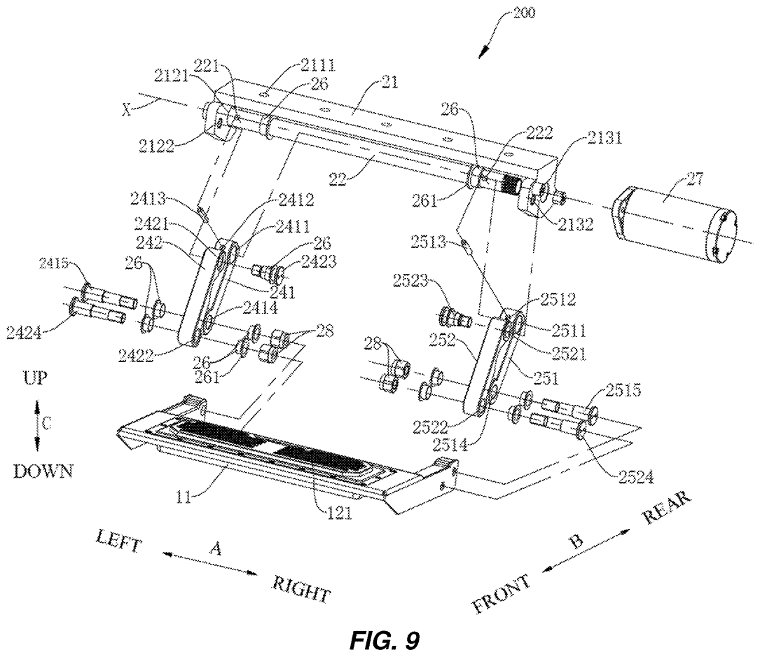

The first support arm assembly 24 is connected to the first side of the step 100. Specifically, the first support arm assembly 24 includes a first drive arm 241 and a first driven arm 242. A first end (i.e., the upper end in FIG. 9) of the first drive arm 241 is fixed to the drive shaft 22, so that the first drive arm 241 is driven to swing when the drive shaft 22 rotates. A second end (i.e., the lower end in FIG. 9) of the first drive arm 241 is pivotally connected to the first side of the step 100. A first end (i.e., the upper end in FIG. 9) of the first driven arm 242 is pivotally connected to the mounting bracket 21, and a second end (i.e., the lower end in FIG. 9) of the first driven arm 242 is pivotally connected to the first side of the step 100.

The second support arm assembly 25 is connected to the second side of the step 100. Specifically, the second support arm assembly 25 includes a second drive arm 251 and a second driven arm 252. A first end (i.e., the upper end in FIG. 9) of the second drive arm 251 is fixed to the drive shaft 22, so that the second drive arm 251 is driven to swing when the drive shaft 22 rotates. A second end (i.e., the lower end in FIG. 9) of the second drive arm 251 is pivotally connected to the second side of the step 100. A first end (i.e., the upper end in FIG. 9) of the second driven arm 252 is pivotally connected to the mounting bracket 21, and a second end (i.e., the lower end in FIG. 9) of the second driven arm 252 is pivotally connected to the second side of the step 100.

As shown in FIGS. 8 and 9, the pivot center between the first drive arm 241 and the first side of the step 100 is located behind the pivot center between the first driven arm 242 and the first side of the step 100. The pivot center between the second drive arm 251 and the second side of the step 100 is located behind the pivot center between the second driven arm 252 and the second side of the step 100. By adjusting the positional relationship between the pivot centers of the first and second sides of the step 100 and the pivot center of the mounting bracket 21, the movement trajectory of the step 100 can be adjusted.

When the drive shaft 22 rotates forward and in reverse, a link mechanism is formed by the first support arm assembly 24, the second support arm assembly 25, the step 100, and the mounting bracket 21. The first drive arm 241 and the second drive arm 251 are driven to swing by the drive shaft 22, thereby driving the first driven arm 242 and the second driven arm 252 to swing synchronously, and thus driving the step 100 to move between the extended position and the retracted position. The retractable step device 200 of this example embodiment has a compact overall structure and occupies a small space, which can improve the passability of the vehicle, especially suitable for vehicles with low chassis.

A retractable step device 200 according to other specific embodiments of the present technology is described below.

As shown in FIGS. 1 to 11, the retractable step device 200 includes a mounting bracket 21, a drive shaft 22, a step 100, a first support arm assembly 24, a second support arm assembly 25, and a drive motor 27.

The mounting bracket 21 includes a mounting plate 211, a first mounting lug 212, and a second mounting lug 213. The mounting plate 211 may be in the shape of a rectangular flat plate. Thus, the mounting plate 211 has no excessive protruding structures or special-shaped structures, improving the compactness of the retractable step device 200. The mounting plate 211 has a plurality of mounting holes 2111, and the mounting plate 211 may be mounted to the vehicle body of the vehicle through fasteners such as bolts passing through the mounting holes 2111. The mounting plate 211 has a first end (i.e., the left end in FIGS. 8 and 9) and a second end (i.e., the right end in FIGS. 8 and 9) along the axial direction of the drive shaft 22. The first mounting lug 212 is provided at the first end of the mounting plate 211, and the second mounting lug 213 is provided at the second end of the mounting plate 211. The first mounting lug 212 extends downward from the first end of the mounting plate 211, and the second mounting lug 213 extends downward from the second end of the mounting plate 211.

The first mounting lug 212 has a first shaft hole 2121 and a first pivot hole 2122 located at the front side of the first shaft hole 2121. The second mounting lug 213 has a second shaft hole 2131 and a second pivot hole 2132 located at the front side of the second shaft hole 2131. Here, front side may refer to directly forward side, upper-front side, or lower-front side.

The drive shaft 22 is located below the mounting plate 211 and adjacent to a lower surface of the mounting plate 211, so that the structure of the mounting bracket 21 and the drive shaft 22 is more compact, occupying a smaller space, further reducing the size of the entire retractable step device 200 in the up-down direction, and further improving compactness.

The drive shaft 22 is rotatably supported within the first shaft hole 2121 of the first mounting lug 212 and the second shaft hole 2131 of the second mounting lug 213. A bushing 26 is provided at one end of the first shaft hole 2121 adjacent to the second mounting lug 213 and one end of the second shaft hole 2131 adjacent to the first mounting lug 212. One end of the bushing 26 is provided with a flange 261. By providing the bushing 26, wear of the first mounting lug 212 and the second mounting lug 213 can be avoided, reducing maintenance costs in the later period. The flange 261 can prevent sand and mud from entering the shaft hole, reducing wear caused by sand and mud. The bushing 26 may be made of a material with a low friction coefficient and good wear resistance, thereby reducing wear of the drive shaft 22, the first shaft hole 2121, and the second shaft hole 2131, improving rotation performance and extending the service life of the components.

The drive shaft 22 may be connected to a drive motor 27 mounted on the mounting bracket 21. The drive motor 27 may be mounted on the first mounting lug 212 or the second mounting lug 213. Preferably, one drive motor 27 is provided, and the one drive motor 27 drives the drive shaft 22 to rotate, thereby driving the first support arm group and the second support arm group to swing, which reduces the number of drive motors 27 and avoids interference caused by the asynchrony of two drive motors 27 or the complex structure and control necessary to ensure the synchrony of two drive motors 27.

As shown in FIGS. 8, 9 and 11, a boss 2133 is provided on the side of the second mounting lug 213 facing away from the first mounting lug 212. The boss 2133 has a threaded hole, and the drive motor 27 may be fixed on the boss 2133 through a fastener such as a bolt. The drive motor 27 is disposed on the side of the second mounting lug 213 facing away from the first mounting lug 212, which can also prevent sand and mud from entering the second shaft hole 2131 from the end of the second shaft hole 2131 far away from the first mounting lug 212.

The structure of the step in the retractable step device 200 of the example embodiment here is the same as that of the step with the weighing function in the above embodiments and will not be repeated.

In the example embodiment, the step 100 has a first side (i.e., the left side in FIGS. 8 and 9) and a second side (i.e., the right side in FIGS. 8 and 9) along the axial direction of the drive shaft 22. The upper surface of the stepping plate 12 and the upper surface of the step body 11 not covered by the stepping plate 12 may be collectively referred to as the stepping surface 121. The step 100 includes a first extension beam 17 and a second extension beam 18. The first extension beam 17 and the second extension beam 18 are arranged at intervals along the axial direction of the drive shaft 22. The first extension beam 17 and the second extension beam 18 are connected to the step body 11 and extend backward from the step body. As shown in FIGS. 8 and 9, the first extension beam 17 is connected to the lower side of the left end of the step body 11, and the second extension beam 18 is connected to the lower side of the right end of the step body 11. In other words, the left end of the step body 11 is supported on the upper surface of the front end of the first extension beam 17, and the right end of the step body 11 is supported on the upper surface of the front end of the second extension beam 18.

The rear end of the first extension beam 17 has a ninth pivot hole 171 and a tenth pivot hole 172 located at the front side of the ninth pivot hole 171. The rear end of the second extension beam 18 has an eleventh pivot hole 181 and a twelfth pivot hole 182 located at the front side of the eleventh pivot hole 181.

The first support arm assembly 24 is pivotally connected to the first side of the step 100. Specifically, the first support arm assembly 24 includes a first drive arm 241 and a first driven arm 242. The first end of the first drive arm 241 and the first end of the first driven arm 242 are adjacent to the first end of the drive shaft 22. The first end of the first drive arm 241 is located at the side of the first mounting lug 212 facing the second mounting lug 213, which may be referred to as the first end of the first drive arm 241 being located at the inner side of the first mounting lug 212.

The drive shaft 22 has a first lock pin hole 221 and a second lock pin hole 222 extending along its radial direction. The first end of the first drive arm 241 has a third shaft hole 2411 and a third lock pin hole 2412 in communication with the third shaft hole 2411. The third shaft hole 2411 at the first end of the first drive arm 241 is fitted over the drive shaft 22. The first end of the first drive arm 241 is fixed to the drive shaft 22 through a first lock pin 2413 passing through the third lock pin hole 2412 and extending into the first lock pin hole 221. Thus, the connection structure between the first drive arm 241 and the drive shaft 22 is simple, stable, and accurately positioned. The second end of the first drive arm 241 has a third pivot hole 2414. The second end of the first drive arm 241 is pivotally connected to the first extension beam 17 through a first pivot 2415 fitted in the third pivot hole 2414 and the ninth pivot hole 171. The first pivot 2415 passes through the ninth pivot hole 171 of the first extension beam 17 and the third pivot hole 2414 of the first drive arm 241 and is connected to a nut 28.

The first end of the first driven arm 242 has a fifth pivot hole 2421, and the second end of the first driven arm 242 has a sixth pivot hole 2422. The first end of the first driven arm 242 is pivotally connected to the first mounting lug 212 through a third pivot 2423 fitted in the first pivot hole 2122 and the fifth pivot hole 2421. The second end of the first driven arm 242 is pivotally connected to the first extension beam 17 through a fourth pivot 2424 fitted in the sixth pivot hole 2422 and the tenth pivot hole 172. The fourth pivot 2424 passes through the tenth pivot hole 172 of the first extension beam 17 and the sixth pivot hole 2422 of the first driven arm 242 and is connected to the nut 28.

The second support arm assembly 25 is connected to the second side of the step 100. Specifically, the second support arm assembly 25 includes a second drive arm 251 and a second driven arm 252. The first end of the second drive arm 251 and the first end of the second driven arm 252 are adjacent to the second end of the drive shaft 22, and the first end of the second drive arm 251 is located at the side of the second mounting lug 213 facing the first mounting lug 212.

The first end of the second drive arm 251 has a fourth shaft hole 2511 and a fourth lock pin hole 2512 in communication with the fourth shaft hole 2511. The fourth shaft hole 2511 at the first end of the second drive arm 251 is fitted over the drive shaft 22. The first end of the second drive arm 251 is fixed to the drive shaft 22 through a second lock pin 2513 passing through the fourth lock pin hole 2512 and extending into the second lock pin hole 222. Thus, the connection structure between the second drive arm 251 and the drive shaft 22 is simple, stable, and accurately positioned.

The second end of the second drive arm 251 has a fourth pivot hole 2514. The second end of the second drive arm 251 is pivotally connected to the second extension beam 18 through a second pivot 2515 fitted in the fourth pivot hole 2514 and the eleventh pivot hole 181. The second pivot 2515 passes through the eleventh pivot hole 181 of the second extension beam 18 and the fourth pivot hole 2514 of the second drive arm 251 and is connected to the nut 28.

The first end of the second driven arm 252 has a seventh pivot hole 2521, and the second end of the second driven arm 252 has an eighth pivot hole 2522. The first end of the second driven arm 252 is pivotally connected to the second mounting lug 213 through a fifth pivot 2523 fitted in the second pivot hole 2132 and the seventh pivot hole 2521. The second end of the second driven arm 252 is pivotally connected to the second extension beam 18 through a sixth pivot 2524 fitted in the eighth pivot hole 2522 and the twelfth pivot hole 182. The sixth pivot 2524 passes through the twelfth pivot hole 182 of the second extension beam 18 and the eighth pivot hole 2522 of the second driven arm 252 and is connected to the nut 28.

The first support arm assembly 24 and the second support arm assembly 25 are located between the first mounting lug 212 and the second mounting lug 213, which can make the structure between the mounting bracket 21 and the first support arm assembly 24 and the second support arm assembly 25 more compact. Moreover, the first support arm assembly 24 and the second support arm assembly 25 are synchronously driven by the drive shaft 22, resulting in better overall structural stability.

As shown in FIGS. 8-10, the second end of the first drive arm 241 and the second end of the first driven arm 242 are connected to the left side of the first extension beam 17, and the second end of the second drive arm 251 and the second end of the second driven arm 252 are connected to the right side of the second extension beam 18. Optionally, the second end of the first drive arm 241 and the second end of the first driven arm 242 are connected to the right side of the first extension beam 17, and the second end of the second drive arm 251 and the second end of the second driven arm 252 are connected to the left side of the second extension beam 18. Therefore, it should be understood that both the left and right sides of the first extension beam 17 may be referred to as the first side of the step 100, and both the left and right sides of the second extension beam 18 may be referred to as the second side of the step 100.

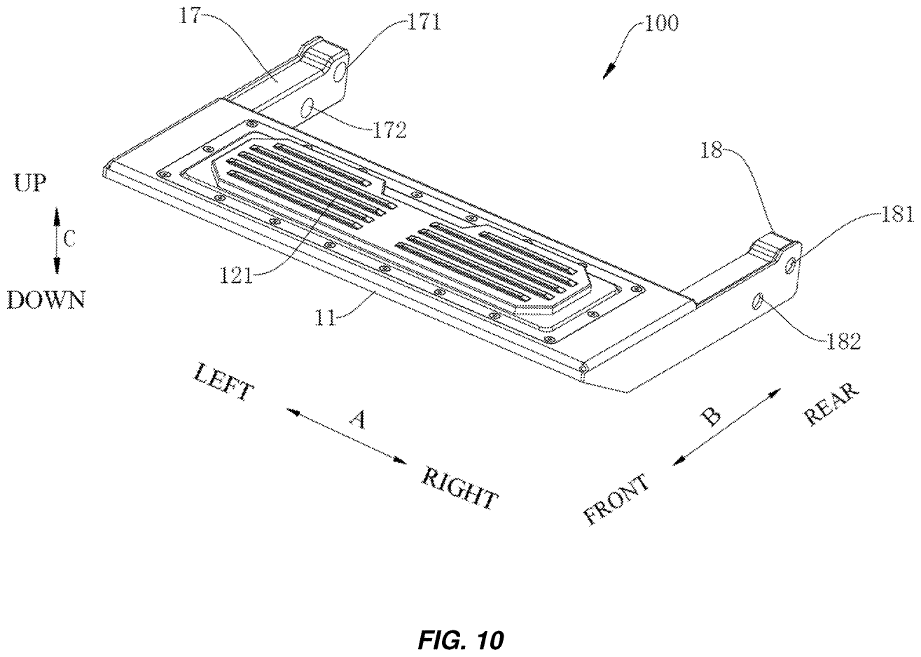

As shown in FIGS. 9 and 10, bushings 26 are respectively fixed at the end of the third pivot hole 2414 away from the ninth pivot hole 171, the end of the ninth pivot hole 171 away from the third pivot hole 2414, the end of the fourth pivot hole 2514 away from the eleventh pivot hole 181, the end of the eleventh pivot hole 181 away from the fourth pivot hole 2514, the end of the fifth pivot hole 2421 away from the first pivot hole 2122, the end of the sixth pivot hole 2422 away from the tenth pivot hole 172, the end of the tenth pivot hole 172 away from the sixth pivot hole 2422, the end of the seventh pivot hole 2521 away from the second pivot hole 2132, the end of the eighth pivot hole 2522 away from the twelfth pivot hole 182, and the end of the twelfth pivot hole 182 away from the eighth pivot hole 2522.

One end of the bushing 26 is provided with a flange 261. By providing the bushing 26, wear of the first drive arm 241, the second drive arm 251, the first driven arm 242, and the second driven arm 252 can be avoided. The flange 261 can prevent sand and mud from entering the pivot hole, thereby reducing wear. The bushing 26 may be made of a material with a low friction coefficient and good wear resistance, thereby improving the transmission performance between components, reducing wear, and extending the service life of the components. After the pivot and the bushing 26 are worn due to long-term relative rotation, only the pivot and the bushing 26 need to be replaced, without replacing the arm assembly, reducing maintenance costs.

Preferably, the second end of the first drive arm 241 and the second end of the first driven arm 242 are respectively pivotally connected to the side of the first extension beam 17 facing away from the second extension beam 18. The second end of the second drive arm 251 and the second end of the second driven arm 252 are respectively pivotally connected to the side of the second extension beam 18 facing away from the first extension beam 17. The first support arm assembly 24 and the second support arm assembly 25 are symmetrically arranged in the left-right direction at the first and second sides of the step 100, improving structural stability.

As described above, the second end of the first drive arm 241 and the second end of the first driven arm 242 may be respectively pivotally connected to the side of the first extension beam 17 facing the second extension beam 18. The second end of the second drive arm 251 and the second end of the second driven arm 252 may be respectively pivotally connected to the side of the second extension beam 18 facing the first extension beam 17.

It can be understood that both the side of the first extension beam 17 facing away from the second extension beam 18 and the side of the first extension beam 17 facing the second extension beam 18 may be referred to as the first side of the step 100, i.e., the left side of the step 100 in FIGS. 8 and 9. Both the side of the second extension beam 18 facing away from the first extension beam 17 and the side of the second extension beam 18 facing the first extension beam 17 are the second side of the step 100, i.e., the right side of the step 100 in FIGS. 8 and 9.

When the drive shaft 22 rotates, it drives the first drive arm 241 and the second drive arm 251 to rotate synchronously, thereby driving the first driven arm 242 and the second driven arm 252 to swing synchronously. A link mechanism is formed by the first support arm assembly 24, the second support arm assembly 25, the step 100, and the mounting bracket 21, thereby driving the step 100 to move between the extended position and the retracted position. In the retracted position, the step 100 can be closer to the vehicle's chassis and farther from the ground, with a compact overall structure and small space occupation, improving the vehicle's passability, especially suitable for a vehicle with low chassis.

A vehicle apparatus according to some specific example embodiments of the present technology is described below.

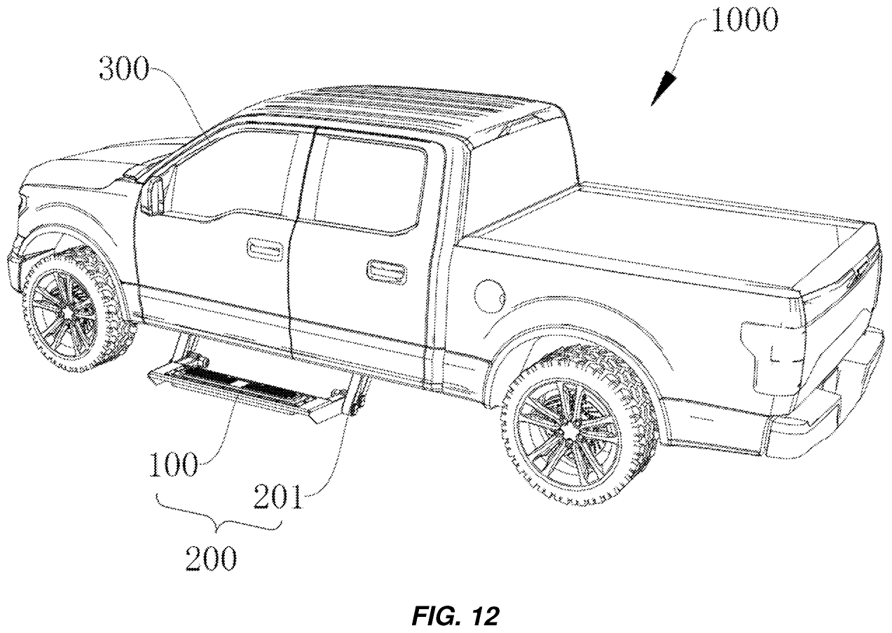

Referring to FIG. 12, the vehicle apparatus 1000 according to some example embodiments of the present technology includes a vehicle 300 and a step 100. The step 100 is mounted on the vehicle 300, and the step 100 is the step 100 with the weighing function described in the above embodiments. The step 100 with the weighing function may be a fixed step.

In some example embodiments, referring to FIG. 12, the vehicle apparatus 1000 further includes a retractable assembly 201. The step 100 is mounted on the vehicle via the retractable assembly 201. When a passenger gets on or off the vehicle, the retractable assembly 201 drives the step 100 to extend, allowing passengers to step on the step 100 for assistance of getting on or off the vehicle. During normal vehicle operation, the retractable assembly 201 drives the step 100 to retract to its retracted position, preventing the step 100 from being hit or damaged. The retractable assembly 201 in the example embodiments includes a mounting bracket 21, a drive shaft 22, the step 100, a first support arm assembly 24, a second support arm assembly 25, and a drive motor 27. The structure of the retractable assembly 201 is the same as the structure of the retractable assembly 201 in the retractable step device 200 in the above embodiments, which will not be further detailed.

When the vehicle has a plurality of side doors on one side, one step may be provided on one side of the vehicle for the plurality of doors, or one step may be provided under each side door. The step may be provided at the rear of the vehicle for the vehicle's tailgate.

The step of the vehicle has a weighing function. When the weight stepping on the step exceeds a preset value, an alarm may be set on the vehicle to avoid damage to the step due to overload. In addition, the weight signal may be displayed on the vehicle's display screen, uploaded to a cloud server, or wirelessly transmitted to a mobile terminal, such as the user's mobile phone. The user may also directly view the information stored on the cloud server through the mobile terminal. Preferably, the preset value may be set and adjusted through the mobile phone or the vehicle's display screen.

The weight signal detected by the step may be uploaded to the cloud server. The cloud server may record the load information applied to the step and periodically generate a load change report of the step. The cloud server may also process and analyze the load information applied to the step to determine whether the step is overloaded and periodically generate an overload use report of the step. The cloud server may send the periodically generated load change report and overload use report to the mobile terminal, and the user may also actively view the load change report and use alarm report on the step through the mobile terminal.

### Conclusion

In the description of the present technology, it should be understood that the orientation or positional relationship indicated by the terms “center,” “longitudinal,” “transverse,” “up,” “down,” “front,” “rear,” “left,” “right,” “vertical,” “horizontal,” “top,”, “bottom,” “inside,” “outside,” “clockwise,” “counterclockwise,” “axial,” “radial,” and “periphery” and the like is based on the orientation or positional relationship shown in the attached drawings, which is only for the convenience of describing the present technology and simplifying the description, and does not indicate or imply that the referred device or element must have a specific orientation, and be constructed and operated in a specific orientation, so it cannot be understood as a limitation of the present technology.

In addition, the terms “first” and “second” are only used for purpose of description, and cannot be understood as indicating or implying relative importance or implicitly indicating the number of indicated technical features. Therefore, the feature defined as “first” or “second” may explicitly or implicitly include at least one such feature. In the description of the present technology, “a plurality of” means at least two, such as two, three, etc., unless otherwise specifically defined.

In the present disclosure, unless otherwise expressly defined, terms such as “install,” “interconnect,” “connect,” and “fix” shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specified. For those skilled in the art, the specific meanings of the above terms in the present disclosure can be understood in specific situations.

In the present disclosure, unless otherwise expressly defined and specified, a structure in which a first feature is “on” or “below” a second feature may include an embodiment in which the first feature is in direct contact with the second feature, or may further include an embodiment in which the first feature and the second feature are in indirect contact through intermediate media. Furthermore, a first feature “on,” “above,” or “on top of” a second feature may include an embodiment in which the first feature is right or obliquely “on,” “above,” or “on top of” the second feature, or just means that the first feature is at a height higher than that of the second feature, while a first feature “below,” “under,” or “on the bottom of” a second feature may include an embodiment in which the first feature is right or obliquely “below,” “under” or “on the bottom of” the second feature, or just means that the first feature is at a height lower than that of the second feature.

In the description of the present technology, terms such as “an embodiment,” “some embodiments,” “an example,” “a specific example” or “some examples” means that a particular feature, structure, material, or characteristic described in connection with the embodiment or example is included in at least one embodiment or example of the present disclosure. Thus, the appearances of these terms in various places throughout this specification are not necessarily referring to the same embodiment or example of the present disclosure. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification.

Although embodiments of the present technology have been shown and described above, it can be understood that the above embodiments are illustrative and shall not be understood as a limitation to the present disclosure, and changes, modifications, alternatives and variations can be made in the above embodiments within the scope of the present disclosure by those skilled in the art.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A step with a weighing function, comprising:
a step body having a support part, a weighing area part, a slot, and a deformation area part, wherein the slot is arranged between the support part and the weighing area part to separate the support part and the weighing area part, and wherein the deformation area part is connected between the support part and the weighing area part;
a stepping plate arranged on the weighing area part; and
a strain gauge arranged on the deformation area part to deform along with deformation of the deformation area part.

2. The step with the weighing function according to claim 1, wherein the support part, the weighing area part, and the deformation area part are all plate-shaped and integrally formed, and a plurality of deformation parts are arranged at intervals along a peripheral direction of the weighing area part.

3. The step with the weighing function according to claim 2, wherein:
the weighing area part is circular and the plurality of deformation area parts are uniformly arranged along the peripheral direction of the weighing area part; or
the weighing area part is polygonal and the plurality of deformation area parts are respectively located at corners of the weighing area part.

4. The step with the weighing function according to claim 1, wherein:
each deformation area part comprises a deformation base, a deformation beam, and a cantilever beam;
the deformation base is connected to the support part;
a first end of the deformation beam is connected to the deformation base, and a second end of the deformation beam is connected to the weighing area part;
a fixed end of the cantilever beam is connected to the deformation base, and the cantilever beam is located on either side of the deformation beam;
the deformation base and the cantilever beam are separated from the support part by the slot;
the cantilever beam and the deformation beam are separated by the slot;
the strain gauge is arranged on the deformation beam; and
the support part has a groove, and the deformation area part is located in the groove.

5. The step with the weighing function according to claim 1, further comprising:
a first pressing plate, a second pressing plate, and an upper waterproof pad, wherein the first pressing plate and the second pressing plate are annular, wherein the upper waterproof pad is deformable; an inner peripheral edge of the upper waterproof pad is press-fitted between a lower surface of the stepping plate and the first pressing plate; and
an outer peripheral edge of the upper waterproof pad is press-fitted between an upper surface of the step body and the second pressing plate.

6. The step with the weighing function according to claim 5, wherein:
a middle portion of the upper surface of the step body is recessed downward to form a recess;
the support part, the weighing area part, and the deformation area part are all located within the recess;
the upper waterproof pad and the second pressing plate are located in the recess;
the outer peripheral edge of the upper waterproof pad is press-fitted between the second pressing plate and a bottom surface of the recess;
an outer peripheral edge of the second pressing plate abuts against a peripheral side wall of the recess, wherein a height of the inner peripheral edge of the upper waterproof pad is larger than a height of the outer peripheral edge of the upper waterproof pad; and
an upper surface of the second pressing plate and an upper surface of the inner peripheral edge of the upper waterproof pad are flush with the upper surface of the step body.

7. The step with the weighing function according to claim 5, further comprising:
a lower waterproof pad and a lower cover plate, wherein the lower cover plate is connected to a lower surface of the step body, and wherein the lower waterproof pad is arranged between the lower cover plate and the step body.

8. The step with the weighing function according to claim 7, wherein the lower cover plate has an accommodating cavity, and a circuit board connected to the strain gauge is arranged within the accommodating cavity.

9. A vehicle apparatus, comprising:
a vehicle; and
a step, wherein the step is mounted on the vehicle, and the step comprises:
a step body having a support part, a weighing area part, a slot, and a deformation area part, wherein the slot is arranged between the support part and the weighing area part to separate the support part and the weighing area part, and wherein the deformation area part is connected between the support part and the weighing area part;
a stepping plate arranged on the weighing area part; and
a strain gauge arranged on the deformation area part to deform along with deformation of the deformation area part.

10. The vehicle apparatus according to claim 9, further comprising a retractable assembly mounted on the vehicle, wherein the retractable assembly is connected to the step to drive the step to move between an extended position and a retracted position.

11. The vehicle apparatus according to claim 10, wherein the retractable assembly comprises:
a mounting bracket;
a drive shaft rotatably mounted on the mounting bracket, wherein the step has a first side and a second side in an axial direction of the drive shaft;
a first support arm assembly having a first drive arm and a first driven arm, wherein a first end of the first drive arm is fixed to the drive shaft, wherein a second end of the first drive arm is pivotally connected to the first side of the step, wherein a first end of the first driven arm is pivotally connected to the mounting bracket, and wherein a second end of the first driven arm is pivotally connected to the first side of the step; and
a second support arm assembly having a second drive arm and a second driven arm, wherein a first end of the second drive arm is fixed to the drive shaft, wherein a second end of the second drive arm is pivotally connected to the second side of the step, wherein a first end of the second driven arm is pivotally connected to the mounting bracket, and wherein a second end of the second driven arm is pivotally connected to the second side of the step.

12. A retractable step device, comprising:
a mounting bracket;
a drive shaft rotatably mounted on the mounting bracket;
a step having a stepping surface, wherein the step has a first side and a second side along an axial direction of the drive shaft;
a first support arm assembly having a first drive arm and a first driven arm, wherein a first end of the first drive arm is fixed to the drive shaft, wherein a second end of the first drive arm is pivotally connected to the first side of the step, wherein a first end of the first driven arm is pivotally connected to the mounting bracket, and wherein a second end of the first driven arm is pivotally connected to the first side of the step; and
a second support arm assembly having a second drive arm and a second driven arm, wherein a first end of the second drive arm is fixed to the drive shaft, wherein a second end of the second drive arm is pivotally connected to the second side of the step, wherein a first end of the second driven arm is pivotally connected to the mounting bracket, and wherein a second end of the second driven arm is pivotally connected to the second side of the step.

13. The retractable step device according to claim 12, wherein the first end of the first drive arm and the first end of the first driven arm are adjacent to a first end of the drive shaft, and the first end of the second drive arm and the first end of the second driven arm are adjacent to a second end of the drive shaft.

14. The retractable step device according to claim 12, wherein:
the mounting bracket comprises a mounting plate, a first mounting lug, and a second mounting lug;
the mounting plate has a first end and a second end along the axial direction of the drive shaft;
the first mounting lug is arranged at the first end of the mounting plate;
the second mounting lug is arranged at the second end of the mounting plate;
the drive shaft is rotatably supported on the first mounting lug and the second mounting lug and is configured to be connected to a drive motor mounted on the mounting bracket; and
the first end of the first driven arm is pivotally connected to the first mounting lug, and the first end of the second driven arm is pivotally connected to the second mounting lug.

15. The retractable step device according to claim 14, wherein:
the mounting plate is a rectangular plate;
the first mounting lug extends downward from the first end of the mounting plate;
the second mounting lug extends downward from the second end of the mounting plate; and
the drive shaft is located below the mounting plate and adjacent to a lower surface of the mounting plate.

16. The retractable step device according to claim 15, wherein the first end of the first drive arm is located on a side of the first mounting lug facing the second mounting lug, and the first end of the second drive arm is located on a side of the second mounting lug facing the first mounting lug.

17. The retractable step device according to claim 14, wherein:
the drive shaft has a first lock pin hole and a second lock pin hole, the first mounting lug has a first shaft hole and a first pivot hole located at a front side of the first shaft hole, and the second mounting lug has a second shaft hole and a second pivot hole located at a front side of the second shaft hole;
the first end of the first drive arm has a third shaft hole and a third lock pin hole in communication with the third shaft hole;
the first end of the second drive arm has a fourth shaft hole and a fourth lock pin hole in communication with the fourth shaft hole;
the drive shaft is rotatably fitted in the first shaft hole and the second shaft hole;
the third shaft hole in the first end of the first drive arm is fitted over the drive shaft, and the first end of the first drive arm is fixed to the drive shaft through a first lock pin passing through the third lock pin hole and extending into the first lock pin hole; and
the fourth shaft hole in the first end of the second drive arm is fitted over the drive shaft, and the first end of the second drive arm is fixed to the drive shaft through a second lock pin passing through the fourth lock pin hole and extending into the second lock pin hole.

18. The retractable step device according to claim 17, wherein:
the second end of the first drive arm has a third pivot hole, and the second end of the second drive arm has a fourth pivot hole;
the first end of the first driven arm has a fifth pivot hole, and the second end of the first driven arm has a sixth pivot hole;
the first end of the second driven arm has a seventh pivot hole, and the second end of the second driven arm has an eighth pivot hole;
the first side of the step has a ninth pivot hole and a tenth pivot hole located at a front side of the ninth pivot hole, and the second side of the step has an eleventh pivot hole and a twelfth pivot hole located at a front side of the eleventh pivot hole;
the second end of the first drive arm is pivotally connected to the step through a first pivot fitted in the third pivot hole and the ninth pivot hole;
the second end of the second drive arm is pivotally connected to the step through a second pivot fitted in the fourth pivot hole and the eleventh pivot hole;
the first end of the first driven arm is pivotally connected to the first mounting lug through a third pivot fitted in the first pivot hole and the fifth pivot hole, and the second end of the first driven arm is pivotally connected to the step through a fourth pivot fitted in the sixth pivot hole and the tenth pivot hole; and
the first end of the second driven arm is pivotally connected to the second mounting lug through a fifth pivot fitted in the second pivot hole and the seventh pivot hole, and the second end of the second driven arm is pivotally connected to the step through a sixth pivot fitted in the eighth pivot hole and the twelfth pivot hole.

19. The retractable step device according to claim 18, wherein bushings are respectively fixed at an end of the first shaft hole adjacent to the second mounting lug, an end of the second shaft hole adjacent to the first mounting lug, an end of the third pivot hole far from the ninth pivot hole, an end of the ninth pivot hole far from the third pivot hole, an end of the fourth pivot hole far from the eleventh pivot hole, an end of the eleventh pivot hole far from the fourth pivot hole, an end of the fifth pivot hole far from the first pivot hole, an end of the sixth pivot hole far from the tenth pivot hole, an end of the tenth pivot hole far from the sixth pivot hole, an end of the seventh pivot hole far from the second pivot hole, an end of the eighth pivot hole far from the twelfth pivot hole, and an end of the twelfth pivot hole far from the eighth pivot hole; and
wherein an end of each bushing is provided with a flange.

20. The retractable step device according to claim 12, wherein the step comprises:
a first extension beam and a second extension beam, the first extension beam and the second extension beam are arranged at intervals along the axial direction of the drive shaft, and the first extension beam and the second extension beam are connected to a step body and extend backward from the step body, and
wherein:
the second end of the first drive arm and the second end of the first driven arm are respectively pivotally connected to a side of the first extension beam facing away from the second extension beam, and the second end of the second drive arm and the second end of the second driven arm are respectively pivotally connected to a side of the second extension beam facing away from the first extension beam; or
the second end of the first drive arm and the second end of the first driven arm are respectively pivotally connected to a side of the first extension beam facing the second extension beam, and the second end of the second drive arm and the second end of the second driven arm are respectively pivotally connected to a side of the second extension beam facing the first extension beam.
